(19) United States
(12) Patent Application Publication
(10) Pub. No.: US 2025/0214854 A1
(43) Pub. Date: Jul. 3, 2025

(54) SYSTEM AND PROCESS FOR PREPARING REFINED INDUSTRIAL REFINED SODIUM CARBONATE

(71) Applicants: Jinhai Lithium(Qinghai) Co., Ltd., Haixi (CN); Eve Energy Co., Ltd., Huizhou (CN)

(72) Inventors: Fan WANG, Haixi (CN); Yingfeng LI, Haixi (CN); Xiaorong WANG, Haixi (CN); Jifeng WANG, Haixi (CN); Yansen LI, Haixi (CN); Guangqing LUAN, Haixi (CN); Mian WANG, Haixi (CN); Tian SANG, Haixi (CN); Jincheng LIU, Haixi (CN)

(73) Assignees: Jinhai Lithium(Qinghai) Co., Ltd., Haixi (CN); Eve Energy Co., Ltd., Huizhou (CN)

(21) Appl. No.: 19/000,761

(22) Filed: Dec. 24, 2024

(30) Foreign Application Priority Data
Dec. 27, 2023 (CN) 202311826526.0
Dec. 27, 2023 (CN) 202323584440.X
Mar. 4, 2024 (WO) PCT/CN2024/079885

(51) Int. Cl. C01D 7/28; B01J 19/00

(52) U.S. Cl. CPC C01D 7/28; B01J 19/0086

(57) ABSTRACT

Disclosed are a system and a process for preparing a refined sodium carbonate solution. The system includes a formulation tank for dissolving an industrial-grade sodium carbonate; a feeding mechanism, an outlet of which is connected to an inlet of the formulation tank; a pH regulator, the pH regulator being disposed in the formulation tank, and the feeding mechanism being connected to the pH regulator; a filtering mechanism, an inlet of which is connected to an outlet of the formulation tank; and an adsorption mechanism, an inlet of which is connected to an outlet of the filtering mechanism.

### RELATED APPLICATIONS

The application claims the benefit of priority, under the Paris Convention, of International Application No. PCT/CN2024/079885, filed on Mar. 4, 2024, Chinese Patent Application No. 202311826526.0, filed on Dec. 27, 2023, and Chinese Patent Application No. 202323584440.X, filed on Dec. 27, 2023. The disclosures of the abovementioned applications are incorporated herein by reference in their entireties.

### TECHNICAL FIELD

The present disclosure relates to the technical field of sodium carbonate purification, and more particularly, to a system and a process for preparing a refined sodium carbonate.

### BACKGROUND

Sodium carbonate, also known as calcined soda, soda, or soda ash, is an important chemical raw material, and also is a main product of soda ash industry. Sodium carbonate usually as a white solid is easily decomposed at high temperature, and soluble in water, and the aqueous solution of sodium carbonate is slightly basic. Sodium carbonate is used in various applications such as glass production, chemicals, metallurgical, ceramic, gas desulfurization, sewage disposal, pharmaceutical, and salt lake lithium extraction industry. Sodium carbonate as an auxiliary material is highly required for its purity and impurity content in production processes of many products, such as optical glass, acid-making agents in pharmaceutical industrial, and battery-grade lithium carbonate. However, industrial-grade sodium carbonate usually contains impurities, and when untreated, it may result in poor product quality, and even some non-conforming indexes. For example, in the salt lake lithium extraction industry, since the industrial-grade sodium carbonate has a high content of magnesium and boron, the resulting lithium carbonate product prepared by lithium deposition has a high content of magnesium and boron, which affects product quality and production efficiency. As the salt lake lithium extraction industry requires a large amount of sodium carbonate, the end use of high-purity sodium carbonate for further production will lead to a sharp increase in costs. Therefore, it is necessary to purify and refine the industrial-grade sodium carbonate.

### SUMMARY

The present disclosure provides a system and a process for preparing a refined sodium carbonate, which is capable of effectively removing impurities in the industrial-grade sodium carbonate.

According to a first aspect, the present disclosure provides a system for preparing a refined sodium carbonate solution including: a formulation tank in which the sodium carbonate is dissolved; a feeding mechanism, an outlet of the feeding mechanism being connected to an inlet of the formulation tank; a pH regulator disposed in the formulation tank and connected to the feeding mechanism, wherein the pH regulator is configured to adjust a pH value in the formulation tank; a filtering mechanism, an inlet of the filtering mechanism being connected to an outlet of the formulation tank; and an adsorption mechanism, an inlet of the adsorption mechanism being connected to an outlet of the filtering mechanism.

According to a second aspect, the present disclosure provides a process for preparing a refined sodium carbonate solution including the steps of:
S1: feeding a volume of a solvent into a formulation tank;
S2: transporting a preset weight of an industrial-grade sodium carbonate by a feeding mechanism to the formulation tank, and dissolving the industrial-grade sodium carbonate in the solvent to form a sodium carbonate solution;
S3: adjusting a pH value of the sodium carbonate solution in the formulation tank by a pH regulator to be in a range of 8 to 13;
S4: transporting the pH-adjusted sodium carbonate solution in the formulation tank to a filtering mechanism to filter out a precipitate formed in the pH-adjusted sodium carbonate solution; and
S5: purifying the filtered sodium carbonate solution by an adsorption mechanism to obtain the refined sodium carbonate solution.

### BRIEF DESCRIPTION OF THE DRAWINGS

FIG. 1 is a schematic diagram of a structure of a system for preparing a refined sodium carbonate solution according to some embodiments of the present disclosure.

FIG. 2 is a flow chart of a process for preparing a refined sodium carbonate solution according to some embodiments of the present disclosure.

### LIST OF REFERENCE SIGNS

1. Formulation tank; 11. Agitator; 2. Feeding mechanism; 21. Gravity discharge bin; 22. De-packing machine; 3. Filtering mechanism; 4. Adsorption mechanism; 5. Storage tank; 6. Fluid reservoir; 7. Liquid supply pump.

### DETAILED DESCRIPTION OF EMBODIMENTS

In some embodiments, the present disclosure provides a storage tank for storing a solvent, wherein an outlet of the storage tank is connected to an inlet of a formulation tank, and a pH regulator is connected to the storage tank.

In some embodiments, the present disclosure further provides a fluid reservoir, wherein an inlet of the fluid reservoir is connected to the outlet of an adsorption mechanism.

In some embodiments, a feeding mechanism includes a gravity discharge bin, wherein an outlet of the gravity discharge bin is connected to the inlet of the formulation tank.

In some embodiments, a de-packing machine is disposed at an inlet of the gravity discharge bin.

In some embodiments, an agitator is disposed in the formulation tank, and the agitator is rotatable relative to the formulation tank to mix a solution in the formulation tank.

In some embodiments, there is further included a liquid supply pump, wherein an inlet of the liquid supply pump is connected to an outlet of the formulation tank, and an outlet of the liquid supply pump is connected to an inlet of the filtering mechanism.

In some embodiments, the filtering mechanism is one or more of a precision filter, a ceramic membrane filter, and a multi-media filter.

In some embodiments, the adsorption mechanism includes at least one adsorption column, and an inlet of the at least one adsorption column is connected to an outlet of the filtering mechanism.

In some embodiments, the adsorption column is filled with a boron-removing resin.

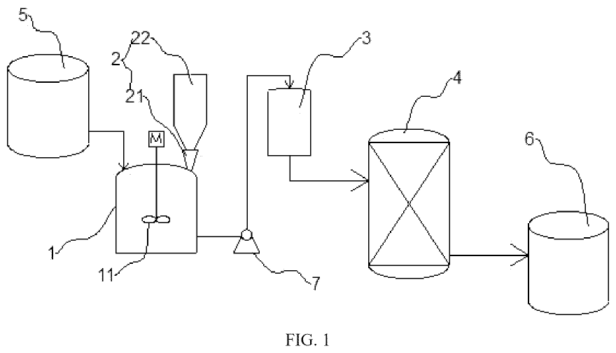

Referring to FIG. 1, the present disclosure provides a system for preparing a refined sodium carbonate solution, and the raw sodium carbonate in the present disclosure is commercially available and in an industrial-grade form. The system includes a formulation tank 1, a feeding mechanism 2, a pH regulator, a filtering mechanism 3 and an adsorption mechanism 4. Optionally, the formulation tank 1 is used to provide a cavity chamber for dissolving the industrial-grade sodium carbonate. An outlet of the feeding mechanism 2 is connected to an inlet of the formulation tank 1. The pH regulator is disposed in the formulation tank 1 for regulating the pH value within the formulation tank 1. The pH regulator is connected to the feeding mechanism 2. An inlet of the filtering mechanism 3 is connected to an outlet of the formulation tank 1. An inlet of the adsorption mechanism 4 is connected to an outlet of the filtering mechanism 3. The industrial-grade sodium carbonate is fed into the formulation tank 1 through the feeding mechanism 2, and dissolved to form a sodium carbonate solution. The pH value in the formulation tank 1 is adjusted by the pH regulator, so that a part of ions such as calcium and magnesium in the sodium carbonate solution form a precipitate. The precipitate is filtered by the filtering mechanism 3. Then, the remaining sodium carbonate solution is purified through the adsorbing mechanism 4 to generate the refined sodium carbonate solution, thereby realizing purification and refinement of the industrial-grade sodium carbonate.

In some embodiments, the formulation tank 1 includes a structure capable of storing solvents and solutions and providing a cavity chamber to dissolve the industrial-grade sodium carbonate, for example, a tank, a barrel, a trunk, or a can. In some embodiments, the feeding mechanism 2 includes a device capable of transferring the industrial-grade sodium carbonate to the formulation tank 1, for example, a conveying pipe, a conveying bin or a conveying hopper. In some embodiments, the pH regulator includes a pH sensor. The pH sensor is disposed in the formulation tank 1, so as to detect the pH value of the solution in the formulation tank 1 and to send the detected pH value signal to an industrial pH meter. It is possible to set high and low limit values for the industrial pH meter according to actual requirements of the production process. The input pH signal is compared with the high and low limit values of the industrial pH meter. According to the compared results, a switching signal or a proportion control signal is output to a control box. Then, the control box can adjust or control the feeding from the feeding mechanism 2 to change the respective proportions of materials in the formulation tank 1, and further to regulate the pH value in the formulation tank 1. In some embodiments, by detecting the pH value of the solution in the formulation tank 1 and then adjusting the amount of the industrial-grade sodium carbonate added from the feeding mechanism 2 to the formulation tank 1, the pH regulator can realize the adjustment to the pH value in the formulation tank 1. In some embodiments, the filtering mechanism 3 is a filtering device capable of filtering the solution at a target pH and removing the generated precipitate or insoluble in the solution. In some embodiments, the adsorption mechanism 4 is used for adsorbing and removing impurities in the solution, thereby achieving purification and refinement of the solution.

In some embodiments, a container and other accommodating device is provided to store a solvent in advance. During the preparation of the solution, the solvent can be directly extracted from the container or the accommodating device and injected to the formulation tank 1, which optimizes the loading process of the solvent. For example, a storage tank 5 is provided for storing the solvent. An outlet of the storage tank 5 is connected to an inlet of the formulation tank 1, and the pH regulator is connected to the storage tank 5. In some embodiments, the solvent is pure water, ultrapure water or distilled water. In some embodiments, when preparing the solution, a volume of the solvent is supplied to the formulation tank 1 in advance through the storage tank 5. When the pH regulator adjusts the pH value in the formulation tank 1, an additional amount of the solvent delivered from the storage tank 5 to the formulation tank 1 is adjusted. In some embodiments, the storage tank 5 is connected to a set of pumps, and the solvent in the storage tank 5 can be transported to the formulation tank 1 by the set of pumps. In some embodiments, a difference in height or water level between the storage tank 5 and the formulation tank 1 is created, so that the solvent in the storage tank 5 can be transported to the formulation tank 1 when a set of valves between the storage tank 5 and the formulation tank 1 are turned on.

In some embodiments, the feeding mechanism 2 includes a gravity discharge bin 21. An outlet of the gravity discharge bin 21 is connected to the inlet of the formulation tank 1. For example, the gravity discharge bin 21 is disposed above the formulation tank 1. When the industrial-grade sodium carbonate is loaded into the gravity discharge bin 21 to a preset weight, the outlet of the gravity discharge bin 21 is turned on, and the industrial-grade sodium carbonate in the gravity discharge bin 21 enters into the formulation tank 1. In some embodiments, the preset weight of the industrial-grade sodium carbonate in the gravity discharge bin 21 is determined by a user. Once the preset weight of the industrial-grade sodium carbonate enters into the formulation tank 1 containing a certain volume of the solvent, a sodium carbonate solution with a preset concentration can be prepared, realizing automatic preparation of the sodium carbonate solution. In some embodiments, the gravity discharge bin 21 includes a bin body for accommodating the industrial-grade sodium carbonate and a weight sensor for determining the weight of the bin body and/or the industrial-grade sodium carbonate contained in the bin body. For example, the weight sensor is configured to determine the weight of the industrial-grade sodium carbonate contained in the bin body. When the industrial-grade sodium carbonate is added to the preset weight, the outlet of the bin body is turned on so that the industrial-grade sodium carbonate in the gravity discharge bin 21 enters into the formulation tank 1.

In some embodiments, when the pH regulator adjusts the pH value in the formulation tank 1, it can detect the pH value of the present solution, and send the detected pH signal to the gravity discharge bin 21 or the storage tank 5, and then the gravity discharge bin 21 or the storage tank 5 discharges corresponding materials to adjust the amount of the industrial-grade sodium carbonate or the solvent in the solution according to the detected pH, thereby changing the pH value in the solution. Under normal conditions, the pH value of the solution made from pure sodium carbonate is at most 12. When the pH value of the solution is required to be greater than or equal to 11.5, sodium hydroxide may be added to increase the pH value of the solution. To this end, the pH regulator further includes a sodium hydroxide feeding module. As a result, the pH regulator can adjust the amount of water and sodium hydroxide to be added, allowing the pH value of the solution to meet the requirements.

In some embodiments, a de-packing machine 22 is disposed at an inlet of the gravity discharge bin 21. In some embodiments, the de-packing machine 22 includes a robotic arm or conveyor belt, which can transport a bag-packed industrial-grade sodium carbonate to a de-packed site. The outer packing bag of the industrial-grade sodium carbonate can be automatically opened by a cutter, an electrothermal bag-breaking device, or the like, so that the industrial-grade sodium carbonate enters into the gravity discharge bin 21. In some embodiments, the de-packed site is disposed above the gravity discharge bin 21. After the outer packing bag of the industrial-grade sodium carbonate is automatically opened by a cutter or other device, the industrial-grade sodium carbonate enters into the gravity discharge bin 21 under the action of gravity. In some embodiments, the de-packed industrial-grade sodium carbonate can be stored in a bin chamber, and then transported to the gravity discharge bin 21 through a conveying device. In some embodiments, the solvent is fed to the formulation tank 1 through the storage tank 5. The outer packing bag of the bag-packed industrial-grade sodium carbonate is opened by the de-packing machine 22, and the industrial-grade sodium carbonate is transported to the gravity discharge bin 21. After reaching the preset weight of sodium carbonate, the outlet of the gravity discharge bin 21 is turned on so that the industrial-grade sodium carbonate in the gravity discharge bin 21 enters into the formulation tank 1, thereby realizing full-automatic feeding of the industrial-grade sodium carbonate.

In some embodiments, an agitator 11 is disposed in the formulation tank 1. The agitator 11 is rotatable relative to the formulation tank 1 to agitate the solution in the formulation tank 1. Further, a driving motor is provided outside the formulation tank 1. The driving motor can drive the agitator 11 to rotate in the formulation tank to agitate the solution in the formulation tank 1, which is beneficial for uniformly mixing the industrial-grade sodium carbonate with the solvent in the formulation tank, and improving the dissolution efficiency of the industrial-grade sodium carbonate in the formulation tank 1 to form the sodium carbonate solution. In some embodiments, the pH value of the solution, which is formed by sufficiently mixing the industrial-grade sodium carbonate with the solvent in the formulation tank 1, can be adjusted by the pH regulator. The pH value of the sodium carbonate solution is adjusted to be in a range of 8 to 13, which allows impurities such as calcium ions and magnesium ions in the sodium carbonate solution to be transformed into a carbonate or hydroxide precipitate.

In some embodiments, the pH-adjusted solution is filtered to remove the precipitate in the solution, so as to decrease impurities such as calcium ions and magnesium ions in the solution and to improve the purity of the solution. In some embodiments, the system includes a liquid supply pump 7. An inlet of the liquid supply pump 7 is connected to the outlet of the formulation tank 1, and an outlet of the liquid supply pump 7 is connected to the inlet of the filtering mechanism 3. The pH-adjusted solution in the formulation tank 1 is transported by the liquid supply pump 7 to the filtering mechanism 3, and the precipitate generated by impurities such as calcium ions and magnesium ions in the solution are filtered. The filtering mechanism 3 is preferably one or more of a precision filter, a ceramic membrane filter and a multi-media filter.

In some embodiments, after the precipitate in the solution is filtered, adsorption is carried out to remove impurities such as boron, potassium, fluorine, manganese, silicon, and organics in the solution. The adsorption mechanism 4 includes at least one adsorption column. An inlet of the at least one adsorption column is connected to the outlet of the filtering mechanism 3. In some embodiments, the adsorption mechanism 4 includes one or more one-stage or multi-stage adsorption columns. The adsorption mechanism 4 improves the impurity removal effect. In some embodiments, the adsorption columns are filled with a boron-removing resin to improve removal of boron in the solution. In some embodiments, the resin in the adsorption column(s) is replaced to improve the removal of other impurities such as potassium, fluorine, manganese, silicon, organics in the solution. In some embodiments, the adsorption mechanism 4 includes a plurality of one-stage or multi-stage adsorption columns, and all or some of the adsorption columns are filled with different resins to individually remove impurities such as boron, potassium, fluorine, manganese, silicon, and organics in the solution, thereby further improving the purity of the sodium carbonate solution to obtain the refined sodium carbonate solution.

In some embodiments, the system includes a fluid reservoir 6. An inlet of the fluid reservoir is connected to an outlet of the adsorption mechanism 4. The fluid reservoir 6 stores the sodium carbonate solution which has been subjected to impurity removal by the adsorption mechanism 4, i.e., the refined sodium carbonate solution.

Referring to FIG. 1, a certain volume of the solvent is transported from the storage tank 5 to the formulation tank 1, and the industrial-grade sodium carbonate is delivered through the feeding mechanism 2 to the formulation tank 1. In some embodiments, the feeding mechanism 2 includes the gravity discharge bin 21, and the de-packing machine 22 is provided at the inlet of the gravity discharge bin 21. The outer packing bag of the industrial-grade sodium carbonate is opened by the de-packing machine 22, and then the industrial-grade sodium carbonate enters into the gravity discharge bin 21. When the industrial-grade sodium carbonate in the gravity discharge bin 21 reaches the preset weight, the outlet of the gravity discharge bin 21 is turned on, and the industrial-grade sodium carbonate in the gravity discharge bin 21 is transported into the formulation tank 1, and dissolved in the solvent to form the sodium carbonate solution. In some embodiments, the agitator 11 is provided in the formulation tank 1, and the agitator 11 is rotatable in the formulation tank, so as to drive the industrial-grade sodium carbonate to uniformly mix with the solvent to form the sodium carbonate solution, improving the dissolution efficiency of the industrial-grade sodium carbonate in the formulation tank 1. Further, the pH regulator detects the pH value of the present sodium carbonate solution, and then a corresponding material, such as the industrial-grade sodium carbonate, sodium hydroxide or the solvent is added to adjust the pH value of the sodium carbonate solution to be in a range of 8 to 13, so that impurities such as calcium ions and magnesium ions in the solution are transformed into a precipitate. Then, the liquid supply pump 7 pumps the pH-adjusted solution in the formulation tank 1 to the filtering mechanism 3 to filter out the precipitate in the sodium carbonate solution, so that the impurities such as calcium ions and magnesium ions in the sodium carbonate solution can be removed, to form the refined sodium carbonate solution. Then, the refined sodium carbonate solution is fed to the adsorption mechanism 4. In some embodiments, the adsorption mechanism 4 includes at least one adsorption column, and the adsorption column(s) is filled with the boron-removing resin to improve the boron removal effect on the solution, achieving removal of the boron impurity in the refined sodium carbonate solution. The boron-removed refined sodium carbonate solution is transported from the adsorption mechanism 4 to the fluid reservoir 6 for storing.

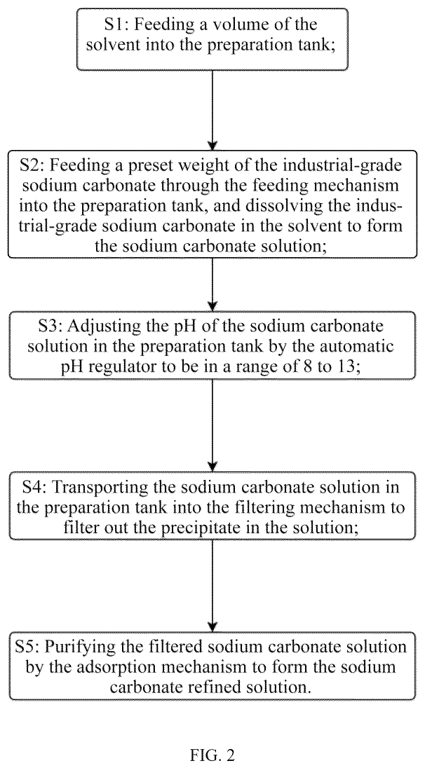

Referring to FIG. 2, the present disclosure provides a process for preparing the refined sodium carbonate solution using the system according to the above embodiments of the present disclosure, including the following steps:

S1: Feeding a volume of the solvent into the formulation tank 1.

The solvent is directly delivered to the formulation tank. Alternatively, in some embodiments, a container or other storing devices is provided to store the solvent in advance, and when a solution is prepared, the stored solvent can be delivered to the formulation tank 1. For example, the solvent is pure water, ultrapure water or distilled water. In some embodiments, the solvent is pre-stored in the storage tank 5, and when the sodium carbonate solution is prepared, a volume of the solvent is delivered from the storage tank 5 to the formulation tank.

S2: Feeding a preset weight of the industrial-grade sodium carbonate through the feeding mechanism 2 into the formulation tank 1, and dissolving the industrial-grade sodium carbonate in the solvent to form the sodium carbonate solution;

The industrial-grade sodium carbonate is delivered into the formulation tank 1 through the feeding mechanism 2, and dissolved to form the sodium carbonate solution. In some embodiments, the feeding mechanism 2 includes the gravity discharge bin 21, and the de-packing machine 22 is provided at the inlet of the gravity discharge bin 21. The bag-packed industrial-grade sodium carbonate is transported to the de-packing machine, and the de-packing machine 22 can automatically open the outer packing bag of the industrial-grade sodium carbonate, so that the industrial-grade sodium carbonate enters into the gravity discharge bin 21. When the industrial-grade sodium carbonate in the gravity discharge bin 21 reaches the preset weight, the outlet of the gravity discharge bin 21 is turned on to discharge the industrial-grade sodium carbonate into the formulation tank 1. In some embodiments, the agitator 11 is provided in the formulation tank 1. The agitator 11 is rotatable in the formulation tank to uniformly mix the industrial-grade sodium carbonate with the solvent to form the sodium carbonate solution, improving the dissolution efficiency of the industrial-grade sodium carbonate in the solvent in the formulation tank 1.

S3: Adjusting the pH of the sodium carbonate solution in the formulation tank 1 by the pH regulator to be in a range of 8 to 13.

The pH regulator can detect the pH value of the sodium carbonate solution in the formulation tank 1, and drive the feeding mechanism 2 to adjust the amount of industrial-grade sodium carbonate added into the formulation tank 1, achieving adjustment of the pH value in the formulation tank 1. Under normal conditions, the pH value of the solution made from pure sodium carbonate is at most 12. When the pH value of the solution is required to be greater than or equal to 11.5, an amount of sodium hydroxide can be added to increase the pH value of the solution. In this case, the pH regulator further includes a sodium hydroxide feeding module. The pH regulator can also adjust the amount of water and sodium hydroxide to be added, so that the pH value of the solution meets the process requirements. The pH-adjusted sodium carbonate solution has a pH in the range of 8 to 13, which allows the impurities such as calcium ions and magnesium ions in the sodium carbonate solution to form a carbonate or hydroxide precipitate in the solution.

S4: Transporting the sodium carbonate solution in the formulation tank 1 into the filtering mechanism 3 to filter out the precipitate in the solution.

The pH-adjusted solution is filtered by the filtering mechanism 3 to remove the precipitate in the solution, thereby reducing impurities such as calcium ions and magnesium ions in the solution, and improving the purity of the solution. The liquid supply pump 7 pumps the pH-adjusted solution in the formulation tank 1 to the filtering mechanism 3, so as to filter out the carbonate or hydroxide precipitate formed by the impurities such as calcium ions and magnesium ions in the solution. The filtering mechanism 3 is one or more of a precision filter, a ceramic membrane filter, and a multi-media filter. The filtering mechanism 3 can filter out the precipitate in the sodium carbonate solution, thereby improving the purity of the solution.

S5: Purifying the filtered sodium carbonate solution by the adsorption mechanism 4 to form the refined sodium carbonate solution.

After the precipitate in the solution is filtered, the filtrate is transported to the adsorption mechanism 4 to further absorb and remove other impurities such as boron, potassium, fluorine, manganese, silicon, and organics in the solution. In some embodiments, the adsorption mechanism 4 includes one or more one-stage or multi-stage adsorption columns. The adsorption mechanism 4 improves the impurity removal effect. In some embodiments, the adsorption column(s) is filled with a boron-removing resin to improve the removal of boron in the solution. In some embodiments, the resin in the adsorption columns is replaced so that the adsorption column(s) can improve the removal of other impurities such as potassium, fluorine, manganese, silicon, and organics in the solution. In some embodiments, the adsorption mechanism 4 includes a plurality of one-stage or multi-stage adsorption columns, and all or some of the adsorption columns are filled with different resins to individually remove impurities such as boron, potassium, fluorine, manganese, silicon, and organics in the solution, thereby further improving the purity of the sodium carbonate solution to obtain the refined sodium carbonate solution.

In some embodiments, the steps S1 to S5 described above are repeated to achieve automated and continuous production of the refined sodium carbonate solution.

In some embodiments, the content of components of the industrial-grade sodium carbonate according to the embodiments of the present disclosure is shown in Table 1:

TABLE 1
Content of components in industrial-grade sodium carbonate

| | | | | | Water-insoluble | Ca²⁺ | Mg²⁺ | B |
|---|---|---|---|---|---|---|---|---|
| Components | Na₂CO₃ | NaCl | Fe³⁺ | Sulphate | substance | (ppm) | (ppm) | (ppm) |
| Content(wt %) | 99.573 | 0.1196 | 0.0003 | 0.0045 | 0.0071 | 62.243 | 63.754 | 3.241 |

### Experimental Example 1

5,000 L of pure water was fed into the formulation tank 1.

The bag-packed industrial-grade sodium carbonate was transported to the automatic de-packing machine. After the outer packing bag of the industrial-grade sodium carbonate was opened by the de-packing machine 22, the industrial-grade sodium carbonate was transported to the gravity discharge bin 21. When the amount of the industrial-grade sodium carbonate in the gravity discharge bin 21 come to 1 ton, the outlet at the lower end of the gravity discharge bin 21 was turned on to discharge the industrial-grade sodium carbonate into the formulation tank 1. At this time, the agitator 11 in the formulation tank 1 was operated to uniformly mix the industrial-grade sodium carbonate with the solvent to dissolve the industrial-grade sodium carbonate.

The pH value of the resulting sodium carbonate solution was adjusted by the pH regulator to be 10.

The pH-adjusted sodium carbonate solution was then pumped by the liquid supply pump 7 into a ceramic membrane filter to filter out particulates or precipitates.

The filtered sodium carbonate solution was subjected to boron removal through the adsorption column, wherein the adsorption column was filled with the boron-removing resin.

When the amount of boron removed from the sodium carbonate solution met the requirements, the resulting refined sodium carbonate solution was stored in the fluid reservoir 6.

The above steps were repeated to achieve automated and continuous production.

### Experimental Example 2

5,000 L of pure water was fed into the formulation tank 1.

The bag-packed industrial-grade sodium carbonate was transported to the automatic de-packing machine. After the outer packing bag of the industrial-grade sodium carbonate was opened by the de-packing machine 22, the industrial-grade sodium carbonate was transported to the gravity discharge bin 21. When the amount of the industrial-grade sodium carbonate in the gravity discharge bin 21 come to 1 ton, the outlet at the lower end of the gravity discharge bin 21 was turned on to discharge the industrial-grade sodium carbonate into the formulation tank 1. At this time, the agitator 11 in the formulation tank 1 was operated to uniformly mix the industrial-grade sodium carbonate with the solvent to dissolve the industrial-grade sodium carbonate.

The pH value of the resulting sodium carbonate solution was adjusted by the pH regulator to be 11.

The pH-adjusted sodium carbonate solution was then pumped by the liquid supply pump 7 into a ceramic membrane filter to filter out particulates or precipitates.

The filtered sodium carbonate solution was subjected to boron removal through the adsorption column, wherein the adsorption column was filled with the boron-removing resin.

When the amount of boron removed from the sodium carbonate solution met the requirements, the resulting refined sodium carbonate solution was stored in the fluid reservoir 6.

The above steps were repeated to achieve automated and continuous production.

### Experimental Example 3

5,000 L of pure water was fed into the formulation tank 1.

The bag-packed industrial-grade sodium carbonate was transported to the automatic de-packing machine. After the outer packing bag of the industrial-grade sodium carbonate was opened by the de-packing machine 22, the industrial-grade sodium carbonate was transported to the gravity discharge bin 21. When the amount of the industrial-grade sodium carbonate in the gravity discharge bin 21 come to 1 ton, the outlet at the lower end of the gravity discharge bin 21 was turned on to discharge the industrial-grade sodium carbonate into the formulation tank 1. At this time, the agitator 11 in the formulation tank 1 was operated to uniformly mix the industrial-grade sodium carbonate with the solvent to dissolve the industrial-grade sodium carbonate.

The pH value of the resulting sodium carbonate solution was adjusted by the pH regulator to be 12.

The pH-adjusted sodium carbonate solution was then pumped by the liquid supply pump 7 into a ceramic membrane filter to filter out particulates or precipitates.

The filtered sodium carbonate solution was subjected to boron removal through the adsorption column, wherein the adsorption column was filled with the boron-removing resin.

When the amount of boron removed from the sodium carbonate solution met the requirements, the resulting refined sodium carbonate solution was stored in the fluid reservoir 6.

The above steps were repeated to achieve automated and continuous production.

### Experimental Example 4

3,000 L of pure water was fed into the formulation tank 1.

The bag-packed industrial-grade sodium carbonate was transported to the automatic de-packing machine. After the outer packing bag of the industrial-grade sodium carbonate was opened by the de-packing machine 22, the industrial-grade sodium carbonate was transported to the gravity discharge bin 21. When the amount of the industrial-grade sodium carbonate in the gravity discharge bin 21 come to 0.5 ton, the outlet at the lower end of the gravity discharge bin 21 was turned on to discharge the industrial-grade sodium carbonate into the formulation tank 1. At this time, the agitator 11 in the formulation tank 1 was operated to uniformly mix the industrial-grade sodium carbonate with the solvent to dissolve the industrial-grade sodium carbonate.

The pH value of the resulting sodium carbonate solution was adjusted by the pH regulator to be 11.

The pH-adjusted sodium carbonate solution was then pumped by the liquid supply pump 7 into a precision filter to filter out particulates or precipitates.

The filtered sodium carbonate solution was subjected to boron removal through the adsorption column, wherein the adsorption column was filled with the boron-removing resin.

When the amount of boron removed from the sodium carbonate solution met the requirements, the resulting refined sodium carbonate solution was stored in the fluid reservoir 6.

The above steps were repeated to achieve automated and continuous production.

### Experimental Example 5

10,000 L of pure water was fed into the formulation tank 1.

The bag-packed industrial-grade sodium carbonate was transported to the automatic de-packing machine. After the outer packing bag of the industrial-grade sodium carbonate was opened by the de-packing machine 22, the industrial-grade sodium carbonate was transported to the gravity discharge bin 21. When the amount of the industrial-grade sodium carbonate in the gravity discharge bin 21 come to 1 ton, the outlet at the lower end of the gravity discharge bin 21 was turned on to discharge the industrial-grade sodium carbonate into the formulation tank 1. At this time, the agitator 11 in the formulation tank 1 was operated to uniformly mix the industrial-grade sodium carbonate with the solvent to dissolve the industrial-grade sodium carbonate.

The pH value of the resulting sodium carbonate solution was adjusted by the pH regulator to be 12.

The pH-adjusted sodium carbonate solution was then pumped by the liquid supply pump 7 into a precision filter to filter out particulates or precipitates.

The filtered sodium carbonate solution was subjected to boron removal through the adsorption column, wherein the adsorption column was filled with the boron-removing resin.

When the amount of boron removed from the sodium carbonate solution met the requirements, the resulting refined sodium carbonate solution was stored in the fluid reservoir 6.

The above steps were repeated to achieve automated and continuous production.

### Comparative Example 1

The industrial-grade sodium carbonate used in the comparative example mainly comprises 99.2 wt % of sodium carbonate, 108.34 ppm of Ca²⁺, 120.51 ppm of Mg²⁺, and 6.42 ppm of B.

The process for preparing the refined sodium carbonate solution in the comparative example was carried out according to the following steps:

5,000 L of pure water was fed into the formulation tank 1.

The bag-packed industrial-grade sodium carbonate was transported to the automatic de-packing machine. After the outer packing bag of the industrial-grade sodium carbonate was opened by the de-packing machine 22, the industrial-grade sodium carbonate was transported to the gravity discharge bin 21. When the amount of the industrial-grade sodium carbonate in the gravity discharge bin 21 come to 1 ton, the outlet at the lower end of the gravity discharge bin 21 was turned on to discharge the industrial-grade sodium carbonate into the formulation tank 1. At this time, the agitator 11 in the formulation tank 1 was operated to uniformly mix the industrial-grade sodium carbonate with the solvent to dissolve the industrial-grade sodium carbonate.

The pH value of the resulting sodium carbonate solution was adjusted by the pH regulator to be 12.

The pH-adjusted sodium carbonate solution was then pumped by the liquid supply pump 7 into a precision filter to filter out particulates or precipitates.

The filtered sodium carbonate solution was subjected to boron removal through the adsorption column, wherein the adsorption column was filled with the boron-removing resin.

When the amount of boron removed from the sodium carbonate solution met the requirements, the resulting refined sodium carbonate solution was stored in the fluid reservoir 6.

The above steps were repeated to achieve automated and continuous production.

The contents of ions respectively in the dissolved solution of the industrial-grade sodium carbonate, in the pH-adjusted solution, and in the final refined sodium carbonate solution prepared in the Experimental Examples 1 to 5 and the Comparative Example 1 were determined, and results are shown in Table 2 below.

TABLE 2

| | After dissolution of industrial-grade | | | After adjustment | | | Sodium carbonate refined | | |
|---|---|---|---|---|---|---|---|---|---|
| | sodium carbonate (ppm) | | | of pH (ppm) | | | solution (ppm) | | |
| | Ca²⁺ | Mg²⁺ | B | Ca²⁺ | Mg²⁺ | B | Ca²⁺ | Mg²⁺ | B |
| Experimental | 12.45 | 13.75 | 0.65 | 0.47 | 5.64 | 0.65 | 0.47 | 5.64 | 0.0026 |
| Example 1 | | | | | | | | | |
| Experimental | 12.44 | 13.74 | 0.64 | 0.21 | 0.86 | 0.64 | 0.21 | 0.86 | 0.0021 |
| Example 2 | | | | | | | | | |
| Experimental | 12.45 | 13.75 | 0.65 | 0.012 | 0.014 | 0.65 | 0.012 | 0.014 | 0.0033 |
| Example 3 | | | | | | | | | |
| Experimental | 10.37 | 11.46 | 0.54 | 0.17 | 0.64 | 0.54 | 0.17 | 0.64 | 0.0027 |
| Example 4 | | | | | | | | | |
| Experimental | 6.22 | 6.88 | 0.32 | 0.08 | 0.06 | 0.32 | 0.08 | 0.06 | 0.0011 |
| Example 5 | | | | | | | | | |
| Comparative | 21.67 | 24.10 | 1.28 | 0.31 | 0.36 | 1.284 | 0.31 | 0.36 | 0.0051 |
| Example1 | | | | | | | | | |

As can be seen from the above embodiments, the process for preparing the refined sodium carbonate solution according to the present disclosure can effectively reduce the content of boron, calcium and magnesium ions from the industrial-grade sodium carbonate with a high content of boron, calcium and magnesium ions, and produce a refined sodium carbonate solution with a low content of boron, calcium and magnesium ions. Therefore, the process can provide conditions for subsequent production of high-purity carbonates such as lithium carbonate. In addition, the process of the present disclosure can provides the sodium carbonate solution with suitable boron, calcium and magnesium concentrations for wide application, and can provide simple process to achieve automation and easiness in industrial production.

According to the system for preparing the refined sodium carbonate solution, the feeding mechanism transports the industrial-grade sodium carbonate to the formulation tank so that the industrial-grade sodium carbonate is dissolved to form an sodium carbonate solution in the formulation tank, and the pH regulator adjusts the pH value in the formulation tank so that a part of impurities in the sodium carbonate solution form a precipitate. After the precipitate is filtered out through a filtering mechanism, the adsorption mechanism further purities the sodium carbonate solution, thereby generating the refined sodium carbonate solution, thereby realizing purification of the industrial-grade sodium carbonate.

What is claimed is:

1. A system for preparing a refined sodium carbonate solution, comprising:
a formulation tank in which an industrial-grade sodium carbonate is dissolved;
a feeding mechanism, an outlet of the feeding mechanism being connected to an inlet of the formulation tank;
a pH regulator disposed in the formulation tank and connected to the feeding mechanism, wherein the pH regulator is configured to adjust a pH value in the formulation tank;
a filtering mechanism, an inlet of the filtering mechanism being connected to an outlet of the formulation tank; and
an adsorption mechanism, an inlet of the adsorption mechanism being connected to an outlet of the filtering mechanism.

2. The system according to claim 1, further comprising a storage tank for storing a solvent, wherein an outlet of the storage tank is connected to the inlet of the formulation tank, and the pH regulator is connected to the storage tank.

3. The system according to claim 1, further comprising a fluid reservoir, wherein an inlet of the fluid reservoir is connected to an outlet of the adsorption mechanism.

4. The system according to claim 1, wherein the feeding mechanism comprises a gravity discharge bin, and an outlet of the gravity discharge bin is connected to the inlet of the formulation tank.

5. The system according to claim 4, wherein a de-packing machine is disposed at an inlet of the gravity discharge bin.

6. The system according to claim 1, wherein an agitator is disposed in the formulation tank, and the agitator is rotatable with respect to the formulation tank to stir a solution in the formulation tank.

7. The system according to claim 1, further comprising a liquid supply pump, wherein an inlet of the liquid supply pump is connected to the outlet of the formulation tank, and an outlet of the liquid supply pump is connected to the inlet of the filtering mechanism.

8. The system according to claim 1, wherein the filtering mechanism is one or more of a precision filter, a ceramic membrane filter and a multi-media filter.

9. The system according to claim 1, wherein the adsorption mechanism comprises at least one adsorption column, and an inlet of the at least one adsorption column is connected to an outlet of the filtering mechanism.

10. The system according to claim 9, wherein the adsorption column is filled with a boron-removing resin.

11. A process for preparing a refined sodium carbonate solution, comprising the following steps of:
S1: feeding a volume of solvent into a formulation tank;
S2: transporting a preset weight of an industrial-grade sodium carbonate from a feeding mechanism to the formulation tank, and dissolving the industrial-grade sodium carbonate in the solvent to form a sodium carbonate solution;
S3: adjusting a pH value of the sodium carbonate solution in the formulation tank by a pH regulator to be in a range of 8 to 13;
S4: transporting the pH-adjusted sodium carbonate solution in the formulation tank to a filtering mechanism to filter out a precipitate formed in the pH-adjusted sodium carbonate solution; and
S5: purifying the filtered sodium carbonate solution by an adsorption mechanism to obtain the refined sodium carbonate solution.

12. The process according to claim 11, wherein in step S1, the solvent is pre-stored in a storage tank, and when a sodium carbonate solution is to be prepared, the volume of the solvent is delivered from the storage tank 5 to the formulation tank.

13. The process according to claim 11, wherein in step S2, the feeding mechanism comprises a gravity discharge bin, and
when the preset weight of the industrial-grade sodium carbonate is present in the gravity discharge bin reaches, an outlet of the gravity discharge bin is opened to discharge the industrial-grade sodium carbonate into the formulation tank.

14. The process according to claim 13, wherein in step S2, the feeding mechanism comprises a de-packing machine connected to an inlet of the gravity discharge bin, and
the de-packing machine discharges the industrial-grade sodium carbonate into the gravity discharge bin.

15. The process according to claim 11, wherein in step S2, an agitator is disposed in the formulation tank, and the agitator is rotatable with respect to the formulation tank to stir a solution in the formulation tank.

16. The process according to claim 11, wherein in step S3, the pH regulator detects a pH value of the sodium carbonate solution obtained in step S2, and controls an amount of the industrial-grade sodium carbonate and the solvent added into the formulation tank according to the detected pH value, so as to adjust the pH of the sodium carbonate solution to be in the range of 8 to 13.

17. The process according to claim 11, wherein in step S4, a liquid supply pump is configured to transport the pH-adjusted sodium carbonate solution to the filtering mechanism.

18. The process according to claim 11, wherein in step S4, the filtering mechanism is one or more of a precision filter, a ceramic membrane filter and a multi-media filter.

19. The process according to claim 11, wherein in step S5, the adsorption mechanism comprises at least one adsorption column, and an inlet of the at least one adsorption column is connected to an outlet of the filtering mechanism.

20. The process according to claim 19, wherein the adsorption column is filled with a boron-removing resin.
